(19) United States
(12) Patent Application Publication
(10) Pub. No.: US 2023/0092170 A1
(43) Pub. Date: Mar. 23, 2023

(54) All Plastic High Pressure Pump

(71) Applicant: APackaging Group LLC, Azusa, CA (US)

(72) Inventor: Armin Arminak, Pasadena, CA (US)

(73) Assignee: APackaging Group LLC, Azusa, CA (US)

(21) Appl. No.: 17/843,782

(22) Filed: Jun. 17, 2022

Related U.S. Application Data
(63) Continuation-in-part of application No. 63/247,730, filed on Sep. 23, 2021.
Application No. 63/247,730 is a continuation-in-part of application No. 17/542,296, filed on Dec. 3, 2021, now Pat. No. 11,471,905.

(51) Int. Cl. F04B 53/10; F04B 53/06; F04B 53/16; F04B 9/14

(52) U.S. Cl. CPC F04B 53/1032; F04B 53/06; F04B 53/16; F04B 9/14; F04B 23/028

(57) ABSTRACT

A manually operated, high pressure pump featuring all plastic construction, is presented. The high pressure is suitable for dispensing liquids in the form of mists. Used pumps do not require disassembly to be recycled.

### CROSS-REFERENCES TO RELATED APPLICATION

This application claims the benefit as a continuation-in-part of U.S. Provisional Application Ser. No. 63/247,730, filed Sep. 23, 2021 and entitled “All Plastic Airless Dispenser,” and as a continuation-in-part of U.S. patent application Ser. No. 17/542,296, filed Dec. 3, 2021 and entitled “All Plastic Airless Pump Dispenser,” both of which are incorporated herein by this reference.

### BACKGROUND OF THE INVENTION

### Field of the Invention

The present invention relates to hand operated liquid dispensing pumps used in the personal care industry and, in particular, to hand pumps comprised of all plastic components and suitable to dispensing liquids as a mist.

### Background Art

Hand operated dispensing pumps are well-known in the personal care industry for dispensing liquids in various forms. Recently, certain all-plastic hand pumps have become available that are well-suited to dispensing liquids in the form of sprays, creams and foams. These pumps have proven less well-adapted to dispensing liquids in the form of mists however, due to a lack of ability to generate sufficient pressure to ensure atomization of the liquid stream. Consequently, the majority of pumps for dispensing liquids as a mist continue to include at least a metal compression spring to generate sufficiently high pressure within the pump chamber to ensure liquid atomization at the nozzle.

Although pumps using metal return springs generate sufficient pressure to dispense liquids as mists and operate effectively, they have certain drawbacks. In particular, the steel compression springs commonly used in such pumps make the pumps difficult to recycle and may cause rust contamination of the product to be dispensed.

Plastic parts are recycled by grinding or shredding the parts. The shredded material may then be reused, typically by melting the material and mixing it with new plastic. To be suitable for grinding or shredding, used plastic must be free of any metal parts. A hand pump using a metal return spring, or any metal components, must be disassembled to remove the metal components prior to recycling the plastic materials which compose the bulk of the pump. The need to disassemble a used hand pump to remove the metal components prior to recycling increases costs and has the effect of decreasing the desirability of used hand pumps as a source of recycled plastic.

As discussed above, there is room for improvement in the art of hand operated, liquid pump dispensers. What is needed is a hand operated, high pressure pump dispenser made of all plastic components, which can generate sufficiently high pressure to ensure atomization, as a mist, of the liquid to be dispensed at the nozzle of the dispenser. Such a design would make hand operated pump dispensers suitable for dispensing liquids as a mist more cost effective to recycle and therefore more desirable as a source of recyclable plastic.

### SUMMARY OF THE INVENTION

The high pressure dispensing pump of the present invention overcomes the disadvantages typically associated with prior art mist dispensing pumps by providing a high pressure pump design suitable for atomizing liquids into mists. The new pump is fabricated entirely from all plastic components which renders the design more cost effective to manufacture and well-suited for recycling. By eliminating the metal compression spring of prior art designs, the new high pressure pump also eliminates potential product contamination with rust which is known to form over time in prior art dispensers using metallic springs.

The high pressure pump of the present invention includes in principle part, an actuator, an elastic return spring, a stem, a stem-retainer, a pump piston, a pump housing, a lower check valve, a chaplet and a pump housing retainer. The actuator includes a flow passage having a liquid inlet at a lower end and a dispensing outlet at an upper end, which is configured as a nozzle. The upper end of the actuator is configured to engage with an upper end of the stem-retainer.

The stem has upper and lower ends with a central flow passage therebetween. At the lower end, the central flow passage terminates in a transverse flow passage having two liquid inlets, where the liquid inlets are selectively opened and closed by the pump piston sliding over a portion of the stem. Thus, the pump piston in conjunction with the stem functions as an upper check valve.

The stem and the pump piston connected thereto are disposed within the pump chamber and reciprocate within the pump chamber via upstrokes and down strokes of the actuator. Disposed between an upper end of the stem-retainer and the chaplet is the elastic return spring. The elastic return spring serves to bias the actuator upwardly so that the actuator returns to its upwards most position after depression of the actuator.

The pump piston is configured with a first annular rib with abuts a second annular rib on the stem. In the high pressure pump's at rest position, the annular ribs are configured such that the first annular rib abuts the second annular rib, from a position below the second annular rib. Consequently, on a downstroke of the actuator, a predetermined pressure or upper check valve opening pressure must be reached in the pump chamber so as to create sufficient force to cause the first annular rib to slide over the second annular rib and thereby allow the pump piston to slide upwardly on the stem and thereby open the two liquid inlets of the stem.

By controlling the (outside) diameter and thus the degree of engagement of the first and second annular ribs, the force required to move the piston upwardly and consequently, the upper check valve opening pressure may be controlled. The first and second annular ribs are configured such the piston will not move, i.e. the upper check valve will not open, until sufficient pressure has built up in the pump chamber to ensure that liquid dispensed from the nozzle of the actuator is sufficiently atomized to be dispensed as a mist

The pump housing is a generally hollow cylindrical body having an upper and a lower end with an interior volume or pump chamber therebetween. The upper end of the pump housing is open and the lower end has a liquid inlet with the lower check valve disposed above the liquid inlet. The pump housing is configured to interface with the pump housing retainer which interfaces with the chaplet. The chaplet interfaces with a dispenser container which will typically be filled with a liquid to be dispensed. A dip tube supplies liquid to be dispensed from the dispenser container to the inlet valve of the pump housing.

The high pressure pump or the present invention may also include a cap which is configured to engage with the chaplet via a snap-fit. The cap covers the actuator and return spring and functions to prevent inadvertent depression of the actuator as may occur during shipping and handling.

The high pressure pump of the present invention functions as follows. In the high pressure pump's at rest position, the first annular rib of the pump piston is disposed below the second annular rib of the stem and abuts the second annular rib. In this position, the pump piston blocks off or closes off the liquid inlets of the stem, which corresponds to the upper check valve being closed. The lower check valve is also closed in the at rest position.

The first full operating cycle of the high pressure pump primes the system. In a first step, the actuator is depressed. As the first down stroke begins, air pressure in the pump chamber increases to the point where the first annular rib of the pump piston slides upwardly over the second annular rib of the stem causing the pump piston to slide upwardly about the stem and uncover the annular flow passages in the stem, which correspond to the upper check valve opening. Also, while the actuator is depressed, the lower check valve is closed, thereby preventing fluid from entering the pump chamber.

As air in the pump chamber is compressed on the down stroke, upon the opening of the upper check valve, pressurized air flows out of the pump chamber and into the liquid inlets of the transverse flow passage, through the central flow passage of the stem into the flow passage of the actuator and exits out the dispensing outlet. As the nozzle is depressed, the elastic return spring is also compressed.

In a second step, upon the actuator being fully depressed and released, the first upstroke commences as the elastic return spring drives the actuator upwardly to its at-rest position. At the start of the upstroke, the second annular rib of the stem is disposed below the first annular rib of the pump piston and abuts the first annular rib. As the upstroke begins, the stem moves upwardly with sufficient force provided by the return spring to cause the second annular rib of the stem to slide upwardly over the first annular rib of the pump piston, thereby causing the pump piston to block or close off the annular liquid inlets in the stem, which corresponds to the upper check valve being closed. Simultaneously, suction within the pump chamber causes the lower check valve to open allowing liquid from the container to enter and fill the pump chamber.

Each subsequent operating cycle of the high pressure pump causes fluid to be dispensed from dispenser outlet of the actuator. In particular, on the second and each subsequent down stroke of the actuator and the stem and pump piston slidably connected thereto, as the stroke commences, the lower check valve closes and after a predetermined pressure in the pump chamber is reached, the pump piston slides upwardly about the stem, opening the liquid inlets of the transverse flow passage. As the upper check valve opens, pressurized fluid begins to flow through the liquid inlets. As the down stroke continues, the liquid within the pump chamber is further pressurized and thus flows through the liquid inlets of the transverse flow passage, through the flow passage of the stem and the flow passage of the actuator and exits from the outlet of the nozzle.

On the second and each subsequent upstroke of the actuator and the stem and pump piston slidably connected thereto, as the upstroke commences, the pump piston slides downwardly about the stem, closing the liquid inlets of the transverse flow passage and the lower check valve opens allowing liquid to be drawn from the container and into the pump chamber. Thus, each operating cycle of the high pressure pump, after the first cycle, causes liquid to be dispensed from the nozzle of the actuator.

The above and other advantages of the high pressure pump of the present invention will be described in more detail below.

### BRIEF DESCRIPTION OF DRAWINGS

FIG. 1 is an exemplary cross-sectional view of the hand operated, high pressure pump of the present invention, showing the position of the pump components in their at-rest position.

FIG. 2 is an enlargement of the area indicated by Circle “A” in FIG. 1.

FIG. 3 is an exemplary cross-sectional view of the hand operated, high pressure pump of the present invention, showing the position of the pump components on a down-stroke of the actuator.

FIG. 4 is an exemplary cross-sectional view of the hand operated, high pressure pump of the present invention, showing the position of the pump components on an upstroke of the actuator.

FIG. 5 is an exemplary exploded, cross-sectional view of the hand operated, high pressure pump of the present invention.

FIG. 6 is an exemplary exploded, perspective view of the hand operated, high pressure pump of the present invention.

FIG. 7 is an exemplary top perspective view of the lower check valve of the hand operated, high pressure pump of FIG. 1.

FIG. 8 is an exemplary bottom view of the lower check valve of the hand operated, high pressure pump of FIG. 7.

FIG. 9 is an exemplary cross-sectional view of the lower check valve of the hand operated, high pressure pump of FIG. 7.

FIG. 10 is an exemplary side of the stem of FIG. 5.

FIG. 11 is an exemplary top view of the stem of FIG. 10.

FIG. 12 is an exemplary side view of the pump piston of FIG. 5, partially cutaway to show an annular rib on the piston.

FIG. 13 is an exemplary top view of the pump piston of FIG. 12.

### DETAILED DESCRIPTION OF THE PREFERRED EMBODIMENTS

The present invention will now be described more fully hereinafter with reference to the accompanying drawings, in which preferred embodiments of the invention are shown. The invention may, however, be embodied in many different forms and should not be construed as being limited to the embodiments set forth herein. Rather these embodiments are provided so that this disclosure will be thorough and complete, and will fully convey the scope of the invention to those skilled in the art. Like numbers refer to like elements throughout.

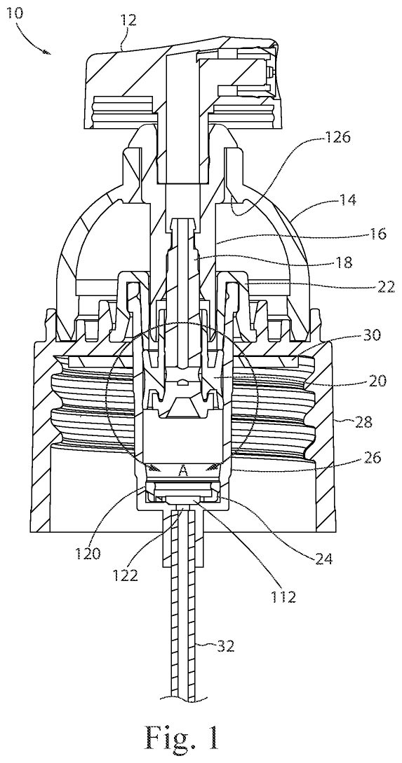

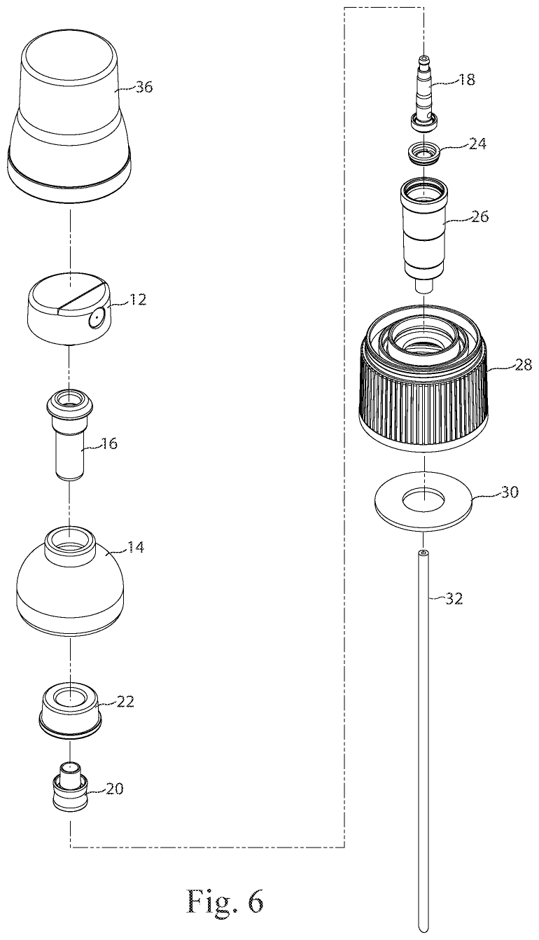

With reference to FIGS. 1-6, and particular reference to FIGS. 1 and 5-6, the high pressure pump 10 of the present invention includes in principle part, an actuator 12, an elastic return spring 14, a stem 18, a stem-retainer 16, a pump piston 20, a pump housing 26, a lower check valve 24, a chaplet 28 and a pump housing retainer 22.

The actuator 12 includes an upper end 38 and a lower end 40 having a flow passage 42 therebetween. The flow passage 42 has a liquid inlet 44 at the lower end 40 of the actuator 12 and a nozzle portion 46 at the upper end 38, wherein the nozzle portion 46 includes an outlet aperture 48 configured to atomize liquid as a mist

The stem-retainer 16 is a generally hollow, cylindrical body having an upper end 50, a lower end 88 and a mid-portion 52. The stem-retainer 16 interconnects the actuator 12 and the stem 18 via snap fit retention features.

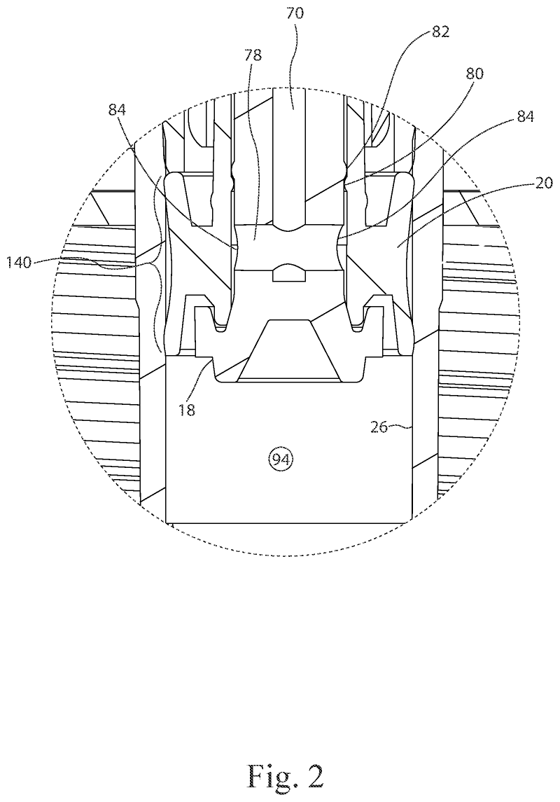

The stem 18 has an upper portion 66 and a lower portion 68 with a central flow passage 70 therebetween. At the lower portion 68, the central flow passage 70 terminates in the transverse flow passage 78 which includes two liquid inlets 84, where the liquid inlets 84 are selectively opened and closed by the pump piston 20 sliding over a cylindrical sliding surface 86 of the stem 18. The pump piston 20 by sliding upwardly and downwardly over a limited distance on the stem 18 uncovers and covers the liquid inlets 84 and thereby functions as an upper check valve 140 (see FIG. 2).

The stem 18 and the pump piston 20 slidably connected thereto are disposed within a pump chamber 94 of the pump housing 26 and reciprocate within the pump chamber 94 via upstrokes and down strokes of the actuator 12. Disposed between an upper end 50 of the stem-retainer 16 and the chaplet 28 is the elastic return spring 14. The elastic return spring 14 serves to bias the actuator 12 upwardly so that the actuator 12 returns to its upwards most or at rest position after depression of the actuator.

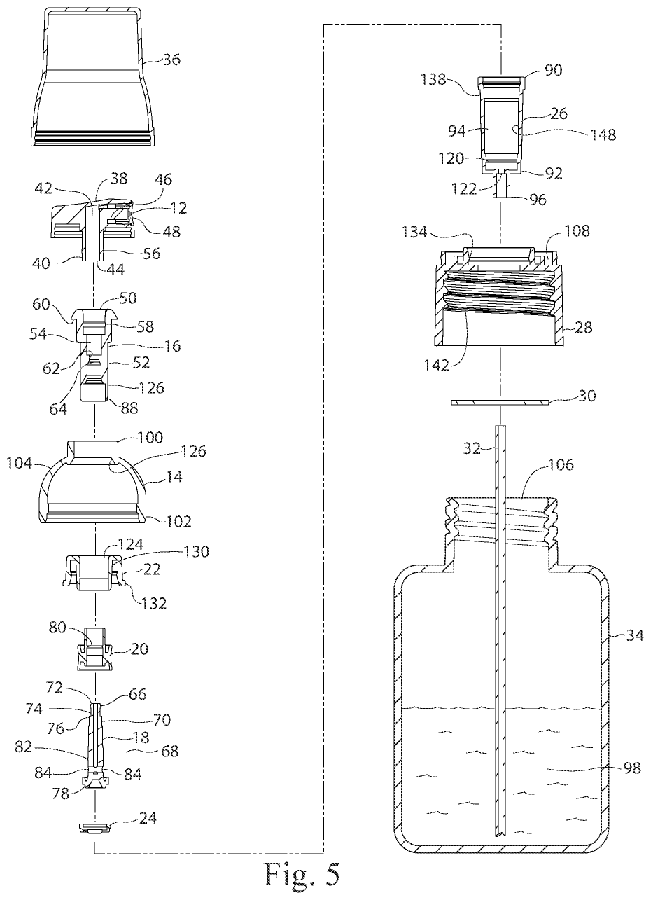

The elastic return spring 14 is generally dome shaped having an upper circular neck 100 and a lower circular lip 102 and a wall thickness 104. The wall thickness 104 may be uniform or, alternatively, may continuously taper from the lower circular lip 102 to the upper circular neck 100. FIG. 5 depicts an embodiment of the elastic return spring 14 where the wall thickness 104 continuously tapers from the lower circular lip 102 to the upper circular neck 100. The elastic return spring 14 also includes an internal circular chamfer 126 which improves flexibility of the spring and venting of the internal area under the dome. One suitable elastic material for the return spring is polyethylene.

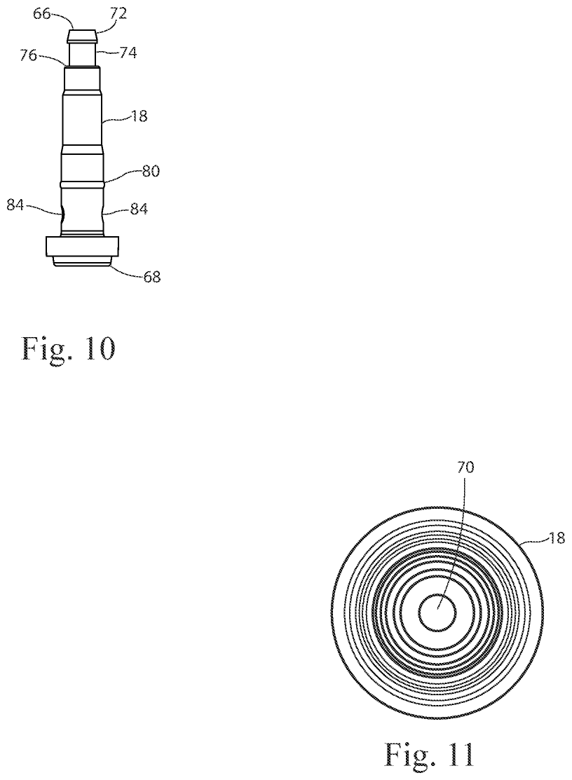

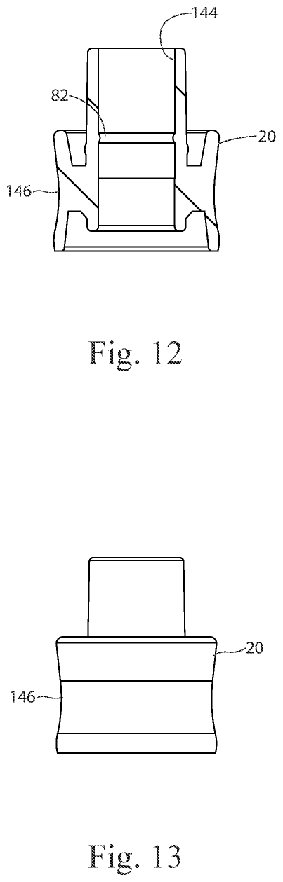

The pump piston 20 is configured with a first annular or transverse rib 80 formed on the interior of a cylindrical bore 144. The first annular rib 80 abuts a second annular or transverse rib 82 on the stem 18. (Best shown in FIGS. 2, 10 and 12.) In the at rest position of the high pressure pump 10, the first annular rib 80 and the second annular rib 82 are configured such that the first annular rib 80 abuts the second annular rib 82, from a position below the second annular rib 82. Consequently, on a down-stroke of the actuator 12, a predetermined pressure or upper check valve opening pressure must be reached in the pump chamber 94 so as to create sufficient force to cause the first annular rib 80 to slide upwardly over the second annular rib 82 and thereby allow the pump piston 20 to slide upwardly on the stem 18 and thereby open the liquid inlets 84 of the transverse flow passage 78 of the stem.

By controlling the outside diameter and thus the degree of engagement of the first annular rib 80 and the second annular rib 82, the force required to move the pump piston 20 upwardly, i.e. the force required to cause the first annular rib 80 of the pump piston 20 to slide upwardly over the second annular rib 82 of the stem 18, and thereby to uncover the liquid inlets 84, may be controlled. The first annular rib 80 and the second annular rib 82 are configured such that the first annular rib 80 will not slide upwardly over the second annular rib 82, and consequently the pump piston 20 will not move upwardly and uncover the liquid inlets 84, until sufficient pressure has built up in the pump chamber 94 to ensure that liquid dispensed from the nozzle portion 46 of the actuator 12 is sufficiently atomized to be dispensed as a mist.

The pump housing 26 is a generally hollow cylindrical body having an upper end 90 and a lower end 92 with an interior volume or pump chamber 94 therebetween. The upper end 90 of the pump housing 26 is open and the lower end 92 has a liquid inlet 96 with the lower check valve 24 disposed above the liquid inlet 96. The pump housing 26 is configured to interface with the pump housing retainer 22 which interfaces with the chaplet 28. The chaplet 28 interfaces with a dispenser container 34 which will typically be filled with a liquid 98 to be dispensed. A gasket 30 is typically used between the chaplet 28 and dispenser container 34 to provide a leak free seal. A dip tube 32 supplies liquid 98 to be dispensed from the dispenser container 34 to the inlet valve 24 of the pump housing.

The chaplet 28 functions to close out an open, upper end 106 of the dispenser container 34 and to suspend the pump housing 26, via a pump housing retainer 22, within the dispenser container. The chaplet 28 will typically include screw threads 142 or other means to attach the chaplet 28 to dispenser container 34. The chaplet 28 includes a circular retention channel 108 which serves to retain the lower circular lip 102 of the dome shaped, elastic return spring 14.

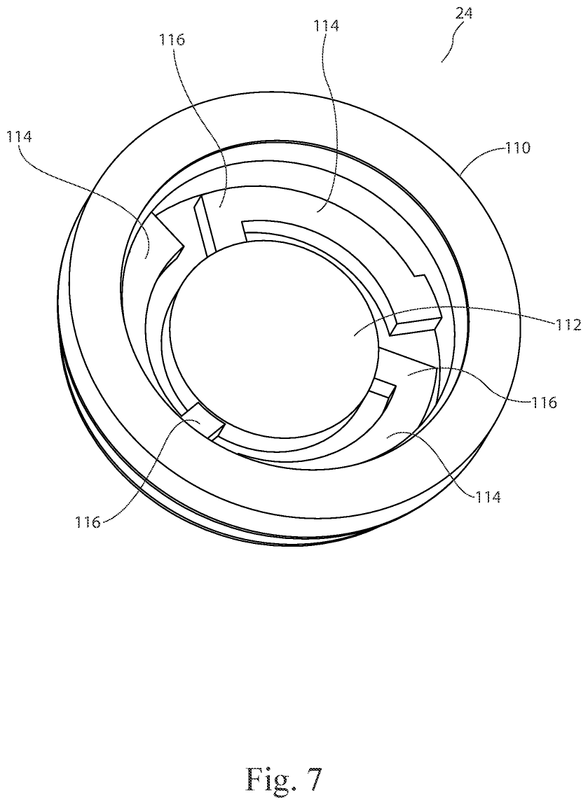

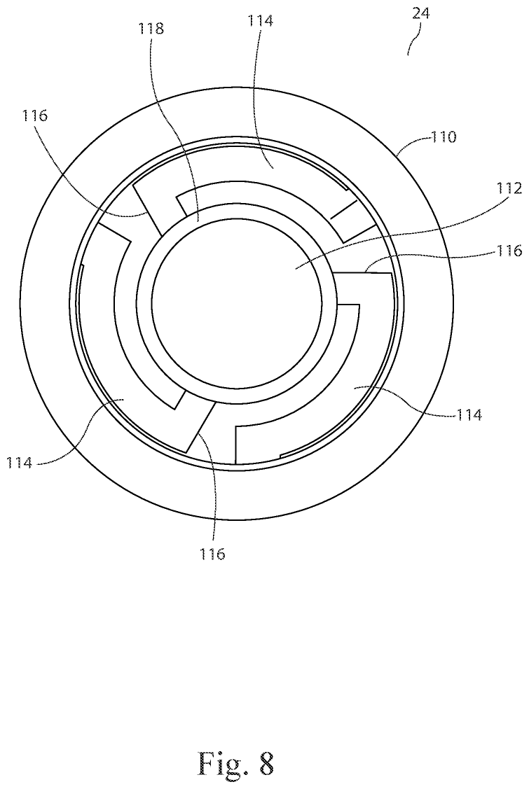

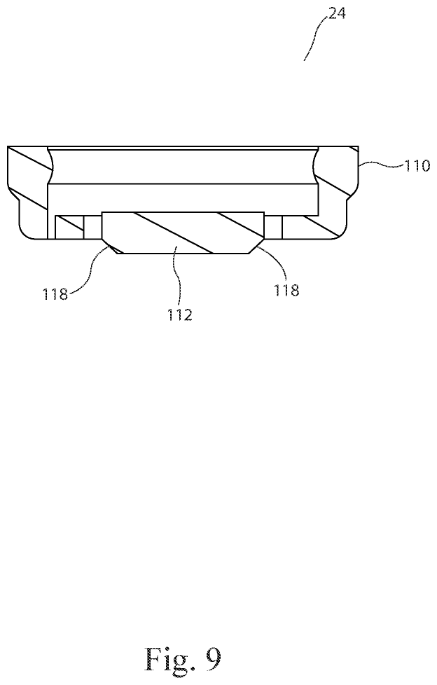

With reference to FIGS. 7-9, the lower check valve 24 is configured as a diaphragm style valve responsive to fluid or gas pressure. In the exemplary embodiment, the lower check valve 24 comprises a ring 110 and a disc shaped sealing element 112, where the disc shaped sealing element 112 is suspended within the ring 110 by means of a plurality of semicircular elastic suspension elements 114 and elastic connector elements 116. In the exemplary embodiment, three semicircular elastic suspension elements 114 and elastic connector elements 116 are equally spaced about the interior perimeter of the ring 110 and exterior perimeter of the disc shaped sealing element 112. The disc shaped sealing element 112 includes a cylindrical chamfer 118, which improves movement of the disc shaped sealing element 112 within a lower cylindrical portion 120 of the pump housing 26.

The lower check valve 24 is configured to seat within the lower cylindrical portion 120 of the pump housing 26, where the disc shaped sealing element 112 abuts an inlet orifice 122 of the pump housing 26. The inlet orifice 122 is in fluid communication with the pump chamber 94 and the liquid 98 in the dispenser container 34 via the dip tube 32.

The lower check valve 24 is made from an elastic material and consequently, seals the inlet orifice 122 against liquid intrusion into the pump chamber 94 on down-strokes of the actuator 12 and stem 18 and pump piston 20 connected thereto. On upstrokes of the actuator 12 and stem 18 and pump piston 20 connected thereto, suction in the pump chamber 94 causes the disc shaped sealing element 112 to lift off the inlet orifice 122 and thereby allows liquid from the dispenser container 34 to enter the pump chamber 94. One suitable elastic material for the lower check valve 24 is polyethylene.

The high pressure pump or the present invention may also include a cap 36 which is configured to engage with the chaplet 28 via a snap-fit. The cap 36 covers the actuator 12 and the elastic return spring 14 and functions to prevent inadvertent depression of the actuator 12 as may occur during shipping and handling.

### Assembly of the High Pressure Pump

With reference to FIGS. 1-6, in a first step, the stem-retainer 16 interconnects with the actuator 12 via a snap-fit. In particular, the lower end 40 of the actuator 12 includes an annular rib 56 which snaps into an annular groove 58 formed within the stem-retainer 16. In a second step, the elastic return spring 14 is slid over the lower end 88 of the stem-retainer until the upper circular neck 100 engages a stop surface 60 of the stem-retainer.

In a third step, the stem-retainer 16 is disposed within an opening 124 of the pump housing retainer 22. In a fourth step, the pump piston 20, via the cylindrical bore 144, is slid over the cylindrical sliding surface 86 of the stem 18 and the first annular rib 80 of the pump piston 20 is seated below the second annular rib 82 of the stem.

In a fifth step, the stem 18 is snapped into the stem-retainer 16. The upper portion 66 of the stem 18 includes snap fit retention features comprising an annular protrusion 72 a tapered annular shoulder 76 and a cylindrical exterior surface 74 therebetween. The mid-portion 52 of the stem-retainer 16 includes snap fit retaining features comprising an annular protrusion 62 above which is disposed a cylindrical pocket 54 and below which is disposed a tapered annular surface 64. To mate the stem 18 to the stem-retainer 16, the annular protrusion 72 of the stem 18 is inserted into the lower end 88 of the stem-retainer until the annular protrusion extends into the cylindrical pocket 54 of the stem-retainer and the tapered annular shoulder 76 of the stem abuts the tapered annular surface 64 of the stem-retainer.

In a fifth step, the lower inlet valve 24 is seated within the lower cylindrical portion 120 of the pump housing 26. In a sixth step, the stem 18 and pump piston 20 connected thereto are slid into the pump housing 26 such that an upper cylindrical engagement portion 128 of the pump housing is snapped into a circular channel 130 of the stem-retainer 16. The pump piston 20 includes a cylindrical sealing surface 146 that engages with an interior wall 148 of the pump housing 26. In a seventh step, the chaplet 28 is slid over the pump housing 26 such that an annular lip 132 of the pump housing retainer engages with an annular recess 134 in the chaplet 28 thereby locking the chaplet to the pump housing retainer. Simultaneously, the lower circular lip 102 of the elastic return spring 14 is positioned so as to engage and reside in a circular channel 108 of the chaplet.

With the completion of step 7, assembly the high pressure pump 10 of the present invention is completed. The high pressure pump 10 may thereafter be installed on a dispenser container 34 by inserting an end of the dip tube 32 into the inlet of the pump housing 26 and thereafter attaching the high pressure pump 10 to the dispenser container 34. Attachment of the high pressure pump 10 to the dispenser container may be accomplished via screw threads as shown in the figures or by a bayonet mount or like attachment means.

### Operation of the High Pressure Pump

With reference to FIGS. 1-6, the high pressure pump 10 of the present invention functions as follows. In the high pressure pump's at rest position (see FIG. 1), the first annular rib 80 of the pump piston 20 is disposed below the second annular rib 82 of the stem 18 and abuts the second annular rib 82. In this position, the pump piston 20 closes off the liquid inlets 84 of the stem 18 and therein blocks the flow of liquid into the transverse flow passage 78 and through the central flow passage 70 of stem 18 and consequently the flow of fluid through the stem-retainer 16 and flow passage 42 and nozzle portion 46 of the actuator 12, all of which are in fluid communication. The lower check valve 24 is also closed in the at rest position.

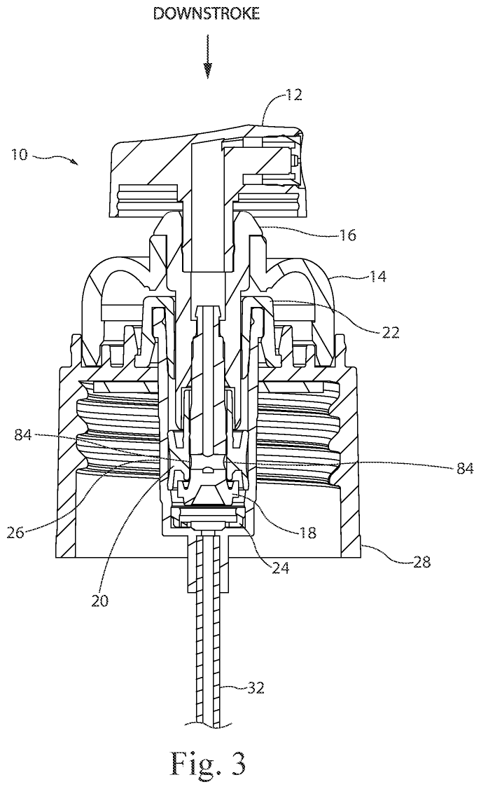

The first full operating cycle of the high pressure pump 10 primes the system. In a first step, the actuator 12 is depressed. (See FIG. 3.) As the first down-stroke begins, air pressure in the pump chamber 94 increases to the point where the first annular rib 80 of the pump piston 20 slides upwardly over the second annular rib 82 of the stem 18 causing the pump piston 20 to slide upwardly about the stem 18 and uncover the liquid inlets 84 in the stem. While the actuator 12 is depressed, the lower check valve 24 is closed, thereby preventing fluid from entering the pump chamber 94.

As air in the pump chamber 94 is compressed on the first down-stroke, upon the pump piston 20 moving upwardly and uncovering the liquid inlets 84, pressurized air flows out of the pump chamber 94 and into the liquid inlets 84 of the transverse flow passage 78, through the central flow passage 70 of the stem 18 into the flow passage 42 of the actuator 12 and exits out the outlet aperture 48. As the actuator 12 is depressed, the elastic return spring 14 is also compressed.

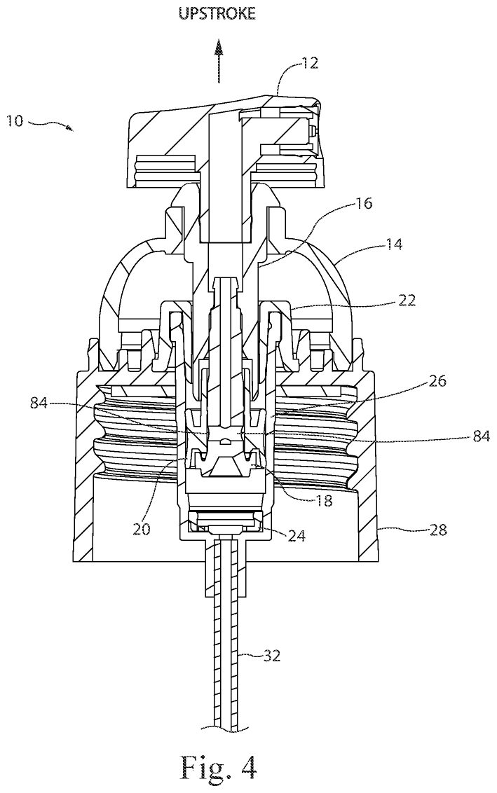

In a second step, upon the actuator 12 being fully depressed and released, the first upstroke commences (see FIG. 4) as the elastic return spring 14 drives the actuator 12 upwardly to its at-rest position. At the start of the upstroke, the second annular rib 82 of the stem 18 is disposed below the first annular rib 80 of the pump piston 20 and abuts the first annular rib 80. As the upstroke begins, the stem 18 moves upwardly with sufficient force provided by the elastic return spring 14 to cause the second annular rib 82 of the stem 18 to slide upwardly over the first annular rib 80 of the pump piston 20, thereby causing the pump piston 20 to block or close off the liquid inlets 84 in the stem 18. Simultaneously, suction within the pump chamber 94 causes the lower check valve 24 to open allowing liquid from the dispenser container 34 to enter and fill the pump chamber 94.

Each subsequent operating cycle of the high pressure pump 10 causes fluid to be dispensed from the outlet aperture 48 of the actuator 12. In particular, on the second and each subsequent down-stroke of the actuator 12 and the stem 18 and pump piston 20 slidably connected thereto, as the down-stroke commences, the lower check valve 24 closes and after a predetermined pressure in the pump chamber 94 is reached, the pump piston 20 slides upwardly about the stem 18, i.e. the first annular rib 80 of the pump piston 20 slides over the second annular rib 82 of the stem 18, opening the liquid inlets 84 of the transverse flow passage 68. As the liquid inlets 84 are uncovered, pressurized fluid begins to flow through the liquid inlets 84. As the down-stroke continues, the liquid within the pump chamber 94 is further pressurized and flows through the liquid inlets 84 of the transverse flow passage 78, through the central flow passage 70 of the stem and the flow passage 42 of the actuator and exits from the outlet aperture 48 of the actuator 12.

On the second and each subsequent upstroke of the actuator 12 and the stem 18 and pump piston 20 slidably connected thereto, as the upstroke commences, the second annular rib 82 slides over the first annular rib 80, thereby causing the pump piston 20 to slide downwardly about the stem 18 and close the liquid inlets 84 of the transverse flow passage 68 as the lower check valve 24 opens allowing liquid to be drawn from the dispenser container 34 into the pump chamber 94. Thus, each operating cycle of the high pressure pump 10, after the first cycle, causes liquid to be dispensed from the outlet aperture 48 of the actuator 12.

The preferred embodiment of the high pressure pump 10 of the present invention which features the use of annular ribs disposed on the pump piston and the stem in order to increase pump pressure has been described herein. In an alternative embodiment, the annular ribs may be removed from the pump. The resulting device will still function, but pressure output will be substantially reduced.

### Venting of the High Pressure Pump

With reference to FIGS. 1-4, the high pressure pump 10 of the present invention is equipped with the an air vent 138 (best shown in FIG. 5) formed in the pump housing 26 which allows air communication between a portion of the pump chamber 94, above the level of the pump piston 20 and atmosphere. The volume enclosed by the dome-shaped, elastic return spring 14 is vented to atmosphere via the slip fit between the upper circular neck 100 of the return spring and the upper end 50 of the stem-retainer 16.

While the present invention has been described with regards to particular embodiments, it is recognized that additional variations of the present invention may be devised without departing from the inventive concept.

1. A hand operated pump made from all plastic materials, for dispensing fluid, comprising:
an actuator having a flow passage with a fluid inlet and a fluid outlet, a stem being rigid and non-collapsible and having an integrally formed annular rib and a flow passage with a fluid inlet and a fluid outlet, a pump piston having an integrally formed annular rib, a pump housing having a fluid inlet, an upper check valve, a lower check valve, and a return spring;
the upper check valve configured to control the flow of fluid through the fluid inlet of the stem;
the lower check valve configured to control the flow of fluid through the fluid inlet of the pump housing;
wherein the actuator, stem and pump piston are interconnected and the pump piston reciprocates within the pump housing upon down-strokes and upstrokes of the actuator;
wherein the upper check valve comprises the pump piston and the fluid inlet of the stem, wherein the pump piston is configured to slide upwardly and downwardly about the stem opening and closing the fluid inlet of the stem;
wherein the lower check valve is a suspended disc configured to close the fluid inlet of the pump housing on down-strokes of the actuator and open the fluid inlet upon upstrokes of the actuator;
wherein the integrally formed annular rib of the pump piston is disposed below the integrally formed annular rib of the stem when the pump is in an at-rest position;
wherein upon a down-stroke of the actuator, the lower check valve closes, and, upon fluid in the pump housing reaching a predetermined pressure, the integrally formed annular rib of the pump piston slides upwardly over the integrally formed annular rib of the stem, opening the fluid inlet of stem; and
wherein upon an upstroke of the actuator, the lower check valve opens, and, the integrally formed annular rib of the pump piston slides downwardly over the integrally formed annular rib of the stem, closing the fluid inlet of stem.

2. The hand operated pump made from all plastic materials, for dispensing fluid of claim 1, wherein the suspended disc is suspended within a ring by a plurality of elastic elements.

3. The hand operated pump made from all plastic materials, for dispensing fluid of claim 2, wherein the plurality of elastic elements are semi-circular and spaced about an interior perimeter of the ring.

4. The hand operated pump made from all plastic materials, for dispensing fluid of claim 1, wherein the fixed annular rib of the pump piston is disposed below the fixed annular rib of the stem and abuts the fixed annular rib of the stem when the pump is in an at-rest position.

5. A hand operated pump made from all plastic materials, for dispensing fluid, comprising:
an actuator having a flow passage with a fluid inlet and a fluid outlet, a stem being rigid and non-collapsible and having a fixed annular rib and a flow passage with a fluid inlet and a fluid outlet, a pump piston having a fixed annular rib, a pump housing having a fluid inlet, an upper check valve, a lower check valve, and a return spring;
the upper check valve configured to control the flow of fluid through the fluid inlet of the stem;
the lower check valve configured to control the flow of fluid through the fluid inlet of the pump housing;
wherein the actuator, stem and pump piston are interconnected and the pump piston reciprocates within the pump housing upon down-strokes and upstrokes of the actuator;
wherein the upper check valve comprises the pump piston and the fluid inlet of the stem, wherein the pump piston is configured to slide upwardly and downwardly about the stem opening and closing the fluid inlet of the stem;
wherein the fixed annular rib of the pump piston is disposed below the fixed annular rib of the stem when the pump is in an at-rest position;
wherein upon a down-stroke of the actuator, the lower check valve closes, and, upon fluid in the pump housing reaching a predetermined pressure, the fixed annular rib of the pump piston slides upwardly over the fixed annular rib of the stem, opening the fluid inlet of the stem; and
wherein upon an upstroke of the actuator, the lower check valve opens, and, the fixed annular rib of the pump piston slides downwardly over the fixed annular rib of the stem, closing the fluid inlet of stem.

6. The hand operated pump made from all plastic materials, for dispensing fluid of claim 5, wherein the lower check valve is a suspended disc configured to close the fluid inlet of the pump housing on down-strokes of the actuator and open the fluid inlet upon upstrokes of the actuator.

7. The hand operated pump made from all plastic materials, for dispensing fluid of claim 6, wherein the suspended disc is suspended within a ring by a plurality of elastic elements.

8. The hand operated pump made from all plastic materials, for dispensing fluid of claim 7, wherein the plurality of elastic elements are semi-circular and spaced about an interior perimeter of the ring.

9. The hand operated pump made from all plastic materials, for dispensing fluid of claim 5, including at least one vent in the pump housing for venting a volume of the housing above the level of the pump piston.

10. The hand operated pump made from all plastic materials, for dispensing fluid of claim 5, wherein the return spring is dome-shaped.

11. The hand operated pump made from all plastic materials, for dispensing fluid of claim 5, wherein the return spring has a continuously tapering wall thickness from a bottom of the spring to a top of the spring.

12. The hand operated pump made from all plastic materials, for dispensing fluid of claim 5, wherein the fixed annular rib of the pump piston is disposed below the fixed annular rib of the stem and abuts the fixed annular rib of the stem when the pump is in an at-rest position.

13. A hand operated pump made from all plastic materials, for dispensing fluid, comprising:
an actuator having a flow passage with a fluid inlet and a fluid outlet, a stem being rigid and non-collapsible and having an integrally formed annular rib and a flow passage with a fluid inlet and a fluid outlet, a pump piston having an integrally formed annular rib, a pump housing having a fluid inlet, a lower check valve and a return spring;
wherein the actuator, stem and housing are in fluid communication;
wherein the lower check valve is configured to control the flow of fluid through the fluid inlet of the pump housing;
wherein the pump piston is slidably connected to the stem and closes the fluid inlet of the stem on down-strokes of the actuator and opens the fluid inlet of the stem on upstrokes of the actuator;
wherein the integrally formed annular rib of the pump piston is disposed below the integrally formed annular rib of the stem when the pump is in an at-rest position;
wherein upon a down-stroke of the actuator, the lower check valve closes, and, upon fluid in the pump housing reaching a predetermined pressure, the integrally formed annular rib of the pump piston slides upwardly over the integrally formed annular rib of the stem, opening the fluid inlet of the stem; and
wherein upon an upstroke of the actuator, the lower check valve opens, and, the annular rib of the pump piston slides downwardly over the annular rib of the stem, closing the fluid inlet of stem.

14. The hand operated pump made from all plastic materials, for dispensing fluid of claim 13, wherein the lower check valve is a suspended disc configured to close the fluid inlet of the pump housing on down-strokes of the actuator and open the fluid inlet upon upstrokes of the actuator.

15. The hand operated pump made from all plastic materials, for dispensing fluid of claim 14, wherein the suspended disc is suspended within a ring by a plurality of elastic elements.

16. The hand operated pump made from all plastic materials, for dispensing fluid of claim 15, wherein the plurality of elastic elements are semi-circular and spaced about an interior perimeter of the ring.

17. The hand operated pump made from all plastic materials, for dispensing fluid of claim 13, including at least one vent in the pump housing for venting a volume of the housing above the level of the pump piston.

18. The hand operated pump made from all plastic materials, for dispensing fluid of claim 13, wherein the return spring is dome-shaped.

19. The hand operated pump made from all plastic materials, for dispensing fluid of claim 13, wherein the return spring has a continuously tapering wall thickness from a bottom of the spring to a top of the spring.

20. The hand operated pump made from all plastic materials, for dispensing fluid of claim 13, wherein the integrally formed annular rib of the pump piston is disposed below the integrally formed annular rib of the stem and abuts the annular rib of the stem when the pump is in an at-rest position.

21. The hand operated pump made from all plastic materials, for dispensing fluid of claim 1, wherein the annular rib of the pump piston and the annular rib of the stem are configured such that the annular rib of the pump piston will not slide upwardly over the annular rib of the stem until sufficient pressure has developed in the pump chamber to dispense fluid from a nozzle in the form of a mist.

22. The hand operated pump made from all plastic materials, for dispensing fluid of claim 5, wherein the annular rib of the pump piston and the annular rib of the stem are configured such that the annular rib of the pump piston will not slide upwardly over the annular rib of the stem until sufficient pressure has developed in the pump chamber to dispense fluid from a nozzle in the form of a mist.

23. The hand operated pump made from all plastic materials, for dispensing fluid of claim 13, wherein the annular rib of the pump piston and the annular rib of the stem are configured such that the annular rib of the pump piston will not slide upwardly over the annular rib of the stem until sufficient pressure has developed in the pump chamber to dispense fluid from a nozzle in the form of a mist.
